(19) United States
(12) Patent Application Publication
(10) Pub. No.: US 2025/0131770 A1
(43) Pub. Date: Apr. 24, 2025

(54) METHOD FOR MEASURING AUDIENCE ATTENTION IN REAL TIME

(71) Applicant: Fahd MEKOUAR, CASABLANCA (MA)

(72) Inventor: Fahd MEKOUAR, CASABLANCA (MA)

(21) Appl. No.: 18/723,640

(22) PCT Filed: Dec. 31, 2021
(86) PCT No.: PCT/MA2021/000026

§ 371 Date: Nov. 20, 2024

(30) Foreign Application Priority Data
Aug. 12, 2021 (MA) 54011

(51) Int. Cl. G06Q 30/0242; G06T 7/50; G06T 7/70; G06V 40/16; H04N 21/258; H04N 21/4223; H04N 21/442

(52) U.S. Cl. CPC G06V 40/174

(57) ABSTRACT

The invention relates to a method for measuring audience attention in real time to assist target customers in gaining a good understanding of their audience through measuring the audience for an object displayed in an electronic device comprising a screen, a camera, monitoring and processing means, a front-office application and a back-office application. The method for measuring audience attention in real time comprises front-office and back-office steps on customer satisfaction from which, depending on the settings, reports may be drawn up and KPIs calculated.

### TECHNICAL FIELD

The present invention relates to the field of digital data processing for the measurement of audience and attention. More precisely, it offers a method of measuring audience and attention in real time by capturing and analyzing a succession of images, which helps targeted clients to better understand their audience.

### PRIOR ART

The use of digital display devices in indoor and outdoor environments is rapidly expanding. These digital display devices can now be installed almost anywhere, as they are designed to be placed in a wide range of indoor and outdoor locations and are available in various sizes. As a result, advertisers are increasingly relying on digital display devices to effectively communicate their messages.

However, unlike other forms of media, it is difficult to measure the effectiveness of multimedia broadcast on a specific digital display device. In particular, it can be difficult to accurately assess audience size and attention levels. Yet, to advertise effectively, it is essential to have information on the size, characteristics, and demographics of the audience that is near and/or viewing a display device. One method for assessing this information involves manually collecting data through human observation of the audience. However, this method is both time-consuming and costly. Moreover, manual observations cannot be easily applied for determining the most appropriate advertisement to display based on audience attributes, especially when there is a large set of advertisements available.

To address the problem mentioned above, prior art has attempted to find out various solutions for measuring the audience for an advertising content. For instance, prior art methods such as those described in patent applications US2009217315A1 and US2011234794A1 have employed a single overhead camera. However, these methods are limited to detecting the location of persons or simply providing a head count. Moreover, such detection systems rely on rudimentary techniques to determine the presence of a person near a video broadcast, such as merging and splitting regions of interest or identifying spots and assuming that each detected head represents one person. Additionally, these methods focus on recognizing movement rather than individual attributes. Consequently, these audience measurement techniques may be inaccurate.

Another disadvantage of general camera systems, such as those mentioned in the patents cited above, is that they typically rely on a single camera that is neither positioned nor equipped to accurately determine audience attributes. While there are advantages to using the aerial perspective provided by overhead camera systems, the information collected may be less accurate than what could be obtained from a front-facing camera, particularly when it comes to measuring audience size and, above all, more importantly its level of attention.

Past efforts have been made to understand customer purchasing behavior by collecting various market research data or to measure the effectiveness of an advertisement in a targeted environment, such as in a multimedia network or in a store.

For example, U.S. Pat. No. 5,331,544 disclosed an automated market research data collection system. A computer system, located at a distance from a plurality of persons, stores surveillance data collected at specific locations. The data collected include sales transactions derived from captured images of customers, which are analyzed using facial recognition technology to verify whether matches with a known gallery of frequent customers are made and attention measurement is based on the assumption that buyers in the collected images are considered to pay attention to the concerned display, regardless of whether the buyers actually looked at the display or not. However, this assumption can be used as a basis for providing an accurate measure of attention only if all shoppers within a predetermined distance from the screen are actually looking at it.

Therefore, it is not appropriate to conclude that customers looked at the screen based solely on the fact that they are within a predetermined distance of the screen in the captured images, unless there is an actual measurement indicating that their head was oriented exactly towards the screen.

Additionally, the U.S. patent describes an automated market research solution that uses a facial recognition technology to track purchases and customers behavior. So, the proposed solution is generally implemented near checkout counters to capture facial images of customers and this is not a universal method. The general idea of using automatic facial analysis to extract information about customers behavior is similar between the American document and the disclosed invention. However, the disclosed invention is aimed more at measuring the effectiveness of the display hardware for the customer audience, rather than measuring purchasing behavior.

So, document US20190034706 attempts to address the problem described above; it describes a computer-implemented method based on face tracking using classifiers in which a plurality of images is captured, received and segmented into a series of image frames. One or more faces are identified and tracked in images using a plurality of classifiers, then the plurality of classifiers is used to estimate a head orientation.

A query is made to determine whether the electronic display was followed by the individual by evaluating and analyzing a series of facial images. This consists in determining if the individual is in front of the screen, facing the screen and looking at the screen in order to assign an engagement score. In this solution, the captured images remain stored in the databases.

No prior art document explicitly or implicitly discloses or suggests a real-time audience measurement method for an object displayed on an electronic device that includes a screen, a camera, processing and monitoring means. Such a method comprises a front-office component based on image processing technologies and an intelligent digital display directed towards the audience, as well as a back-office component that monitors the front-office by presenting statistics while-ensuring content monitoring.

### DISCLOSURE OF THE INVENTION

The present invention seeks to address simultaneously the aforementioned drawbacks by proposing a universal, real-time audience measurement method that is multi-device (Tablets, Smartphones, computers, LED Panels, aso.) and multi-platform (Android, Windows, . . . ). This method not only measures audience attention but also allows for real-time interaction with the broadcast content.

The invention therefore aims to provide a real-time reporting and display solution for the data collected, which helps targeted customers to fully understand their audience through audience measurement and to monitor the broadcast content.

The proposed method is a computer-implemented method which measures the audience in real time for an object, a video or multimedia broadcast displayed on an electronic device that includes a screen, a camera, processing and monitoring means, a front-office application and a back-office application. This method involves a succession of steps to achieve its objectives.

### SUMMARY DESCRIPTION OF FIGURES

The invention will be well understood, and other features and advantages thereof will appear, with reference to the appended schematic drawings, representing, as an example for illustrative and non-limitative purpose, a preferred embodiment of the invention.

The ways of implementing the invention, along with the resulting advantages, will become clear from the description, supported by the accompanying figures in which:

FIG. 1: shows an overview of an embodiment example of the present invention for measuring, in real time, the audience and its attention paid to an object displayed in an electronic device comprising a screen and a camera, processing means, monitoring means for launching a series of steps to be executed in the front-office component in order to determine time, viewing duration, age group, gender and other data.

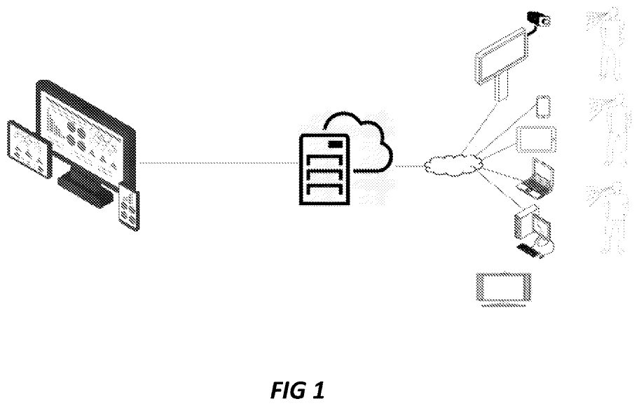

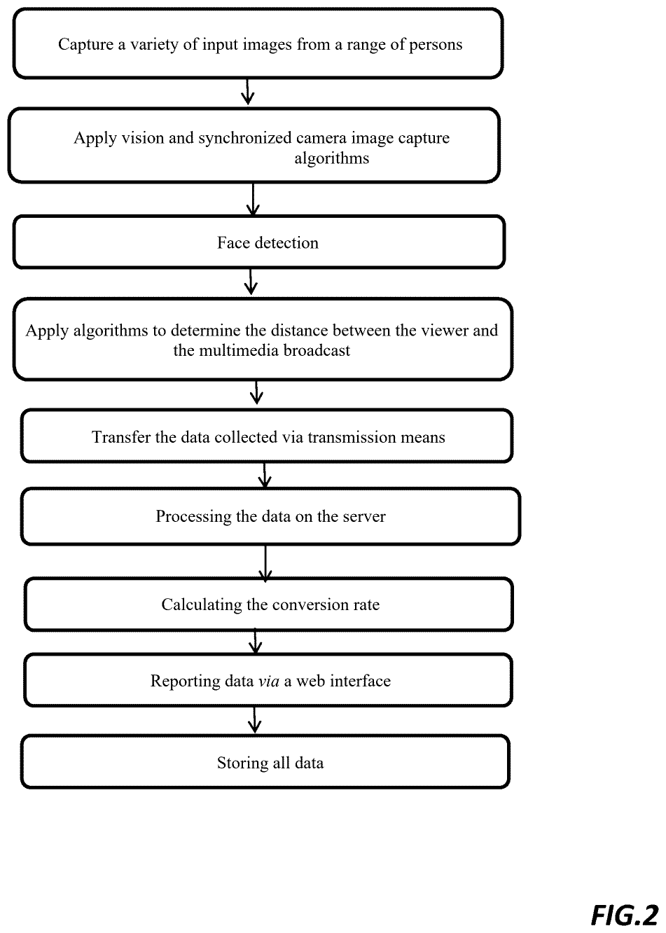

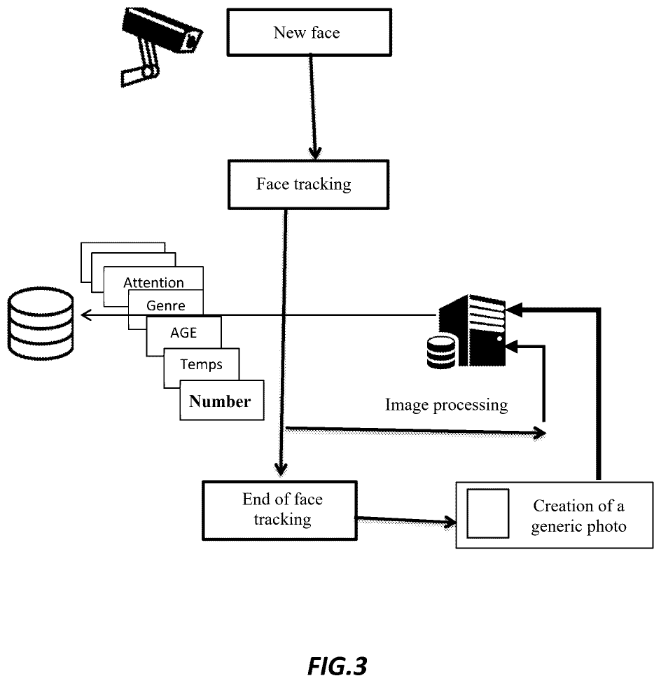

In the embodiment example illustrated in FIG. 1, the displayed object may include elements displayed on screens or on various digital media equipped with cameras, or on electronic devices (a tablet, a computer, a Smartphone, a television or electronic advertising panels, aso) connected via the internet to a Cloud server by communication means. In the present invention, the audience also includes impression level, number of impressions, such as the number of persons who have actually seen said displayed object, impression duration, distribution of impressions by time of day, gender, and evaluation of the effectiveness of a media broadcast according to the duration of the visualization of the same. Then these data are used by the back-office in order to exploit and visualize reports.

FIG. 2: provides an overview of the steps of the method for measuring audience and attention and for monitoring content in the front-office component. In the embodiment example, the method begins with detection of a face, extraction of usable data and sending of the same to the Cloud server for processing. The method closes upon detecting the absence of the previously detected face.

FIG. 3: illustrates an overview of the data collection trigger in an embodiment example of the present invention. When new faces are detected during the video broadcast, the front-office component detects a face, then the necessary information are extracted and sent to the Cloud server for processing and calculation of the indicators.

One of the advantages of the present invention is that the detected face is not recorded, only the extracted data are saved.

We ensure that the server retains no personal data for more than a few seconds, while they are being analyzed.

### DETAILED DESCRIPTION OF THE INVENTION

The front-office component is based on image processing technologies and intelligent, interactive digital displays directed towards viewers. Said front-office comprises: equipment for acquiring images of one or more persons (via a camera) who are viewing a multimedia broadcast on an electronic display device, such as a smartphone, a tablet, an advertising panel, a computer, aso.

A computer-implemented method for real-time audience and attention measurement, involving the following steps on the front-office component:
Capturing a plurality of input images of multiple persons where a displayed content is broadcast on electronic devices equipped with cameras for face detection, with processing and monitoring means and with display devices.
Applying vision and camera synchronized image-capture algorithms using at least one monitoring and processing mean;
Detecting a person's face using data from a telemetry unit or from other devices, along with video image data, to assist in face detection and tracking, using at least one monitoring and processing mean;
Applying algorithms to determine the distance between the person viewing the multimedia broadcast and the electronic display mean;
Transmitting the collected data to a Cloud server via communication mean for storage in memory;
Processing images stored at a Cloud server from its memory in order to extract reliable data: gender, age group, the number of potential viewers for a given medium, time, number of persons who actually turned their gaze towards said given medium, distance: the last distance measured between the viewer and said medium
Calculating the conversion rate by dividing the number of actual viewers by the OTS (the number of potential viewers for said medium);
Storing all the data in real time on a database. Said data are reported via a web interface that is connected to the server computer via data transmission lines,
Closing the session when the detected face through the cameras disappears from the plurality of input images.
Creating a generic image with a solid color to replace the last captured image of a person in order to delete personal data from memory.

In an exemplary embodiment, the invention also includes a back-office component that enables the monitoring of the front-office component by presenting statistics and reporting on a client computer in real time, or at a specific time on a portal accessible via a login and a secure password.

The present computer-implemented method for real-time audience and attention measurement also includes a step in the back-office component that involves collecting key performance indicators (KPI) from network resources connected to the Cloud server.

In another embodiment of the invention, the computer-implemented method for real-time audience measurement is characterized in that it includes a step which consists in determining the facial orientation of the faces detected by cameras to evaluate audience attention through artificial intelligence algorithms.

A computer-implemented method for real-time audience measurement according to claim 4, is characterized in that it includes a step of calculation of the conversion rate, which corresponds to the percentage of detected face pairs between the new input face image and the previous face image.

In the step cited above, the method consists in determining, for each multimedia broadcast on digital display media, a relationship between the collected KPI values and the configured indicators.

Configuration of the indicators consists in personalizing the dashboard by choosing several indicators
Statistics search: Statistics search for a specific date
Extraction of statistics: All statistics can be extracted into digital files using the extension desired by the user.

In another embodiment of the invention said method comprises an additional step in the back-office which consists in monitoring the content of the medium to be broadcast on the display element according to the collected data and to information on the effectiveness of said broadcast medium (conversion rate) in order to be able to change the content of said broadcast medium with a view to deliver to a display element a targeted medium.

1. A computer-implemented method for real-time audience measurement on a device equipped with a front-office application for an object displayed on an electronic device with a display screen, a camera, processing means, monitoring means and transmission means, and a back-office application on a Cloud server, the method comprising:
Capturing a plurality of input images of multiple persons viewing objects displayed or broadcast on electronic devices equipped with cameras for face detection, processing means, monitoring means, transmission means and display elements;
Applying vision and camera synchronized image capture algorithms using monitoring and processing means;
Detecting a person's face using data from a telemetry unit or another device and video image data to assist in face image detection and face tracking using monitoring and processing means;
Applying algorithms through processing means to determine a distance between the person viewing the multimedia broadcast and the respective electronic display;
Transmitting the collected data to a Cloud server via a communication mean for storage in memory;
Processing images stored at the Cloud server from its memory to extract data on: gender, age group, a number of potential viewers for the respective medium, time, a number of persons who actually directed their gaze towards said medium, distance and the last distance measured between a said viewer and said medium;
Calculating a conversion rate by dividing a number of actual viewers by the the number of potential viewers for said medium;
Storing all the data in real-time on a database, said data being reported via a web interface connected to the server through data transmission lines;
Closing a session when the face detected through the cameras disappears from the plurality of input images; and
Creating a generic image with a solid color to replace the last captured image of a person, ensuring deletion of personal data from memory.

2. A computer-implemented method for real-time audience measurement according to claim 1, further comprising:
Authenticating a user on a client machine;
Configurating indicators on an interface of said client machine: age; gender, time slot;
Collecting information stored in the server based on traffic data, including a number of persons who viewed the respective screen or display element and the conversion rate of a displayed advertising sequence;
Displaying statistics on the client machine display device.

3. A computer-implemented method for real-time audience measurement according to claim 2, further comprising, in the back-office component allowing, from network resources, the interfacing of data collected from the front-office to communicate said data between the server and a client host in order to collect key performance indicators (KPI).

4. A Computer-implemented method for real-time audience measurement according to claim 3, further comprising determination of orientations of faces detected by cameras in order to evaluate audience attention through artificial intelligence algorithms.

5. A computer-implemented method for real-time audience measurement according to claim 4, further comprising calculation of the conversion rate for each pair of detected faces, between a new input image of a face detected by cameras and a previous face image in order to provide information on effectiveness of a media broadcast or of a display.

6. A computer-implemented method for real-time audience measurement according to claim 5, further comprising a step in the back-office component for monitoring the media content to be broadcast on the display element of the device equipped with the front-office application, according to the data collected.
